(19) United States
(12) Patent Application Publication
(10) Pub. No.: US 2005/0112536 A1
(43) Pub. Date: May 26, 2005

(54) Method and system for performing and delivering analysis of sports activities

(76) Inventor: Felix Frayman, Henderson, NV (US)

Correspondence Address: FELIX FRAYMAN, 22 TARRYALL TERRACE, HENDERSON, NV, 89074, US

(21) Appl. No.: 10/719,383

(22) Filed: Nov. 21, 2003

(51) Int. Cl. G09B 9/00

(52) U.S. Cl. 434/247; 434/258

(57) ABSTRACT

A method of performing and delivering analysis of an activity includes receiving input from a user via a communication device. The input provided by the user is processed. Analysis information of the activity is generated based on the input provided by the user. The analysis information of the activity is provided to a requester.

### COPYRIGHT NOTICE

Materials contained herein are subject to copyright protection. The copyright owner has no objection to the facsimile reproduction of the patent disclosure by anyone as it appears in the Patent and Trademark Office patent files or records, but otherwise reserves all rights to the copyright whatsoever.

### BACKGROUND OF THE INVENTION

1. Field of the Invention

The present invention relates to methods and systems for recording progression of sports activities and delivering analysis information of such events to participants and spectators of the event, or other interested parties.

2. Discussion of the Related Art

Participants in a sports activity usually strive to improve their performance in a game. In order to improve performance, it is necessary to analyze the activity beyond the scores kept as part of the activity. Such analysis may contain statistical information about individual movements in the game, interesting patterns of movement, strategies, and improvement recommendations. Similarly, spectators of sports activities often desire to gain insights into the observed activity as well.

There are several existing products on the market primarily targeting professional tennis instructors that provide the ability to analyze tennis games. Also, there are systems that are used during broadcasts of tennis matches on television to create match statistical analysis.

Existing products for analyzing progression of sports activities are generally divided into three categories: (1) software products running on a computer; (2) software products running on a personal digital assistant (PDA) device; and (3) specialized electronic hardware products the size of a PDA.

Computer-based programs require a fairly bulky computer or a relatively expensive Pocket PC-type device to be brought to the game. PDA-based programs may utilize a touch sensitive screen to enter data, which requires the observer to take his/her eyes away from the game to enter the data. For a fast-moving game, this mode of input may lead to missing portions of a game.

All such products usually require a prior purchase of a specialized appliance, or a software program that requires a computer, PDA, or specialized electronic device present for such recording. Such purchases limit applicability of the existing products only to the top players or tennis professionals that can amortize the cost of such a purchase over a series of matches.

Existing systems at best allow comparisons to statistical averages based on the match information entered via a specially purchased system. These systems do not have access to the data entered via other units.

Also, none of the existing systems can be used by a participant of a match. All of them require a third-party observer to enter the information into the system.

And finally, in existing systems, the statistical information is available in real time only to the person performing the data entry. There are no easy means of delivering such information to the spectators.

Accordingly, it is desirable to provide methods and systems for recording and delivery of sports activity analysis by imposing as little as possible of a burden on the user.

### BRIEF DESCRIPTION OF THE DRAWINGS

FIG. 1 illustrates a block diagram of process components involved in delivery of game analysis services according to an embodiment of the present invention;

FIG. 2 illustrates sample standard telephone keypad key encodings for a singles tennis match according to an embodiment of the present invention;

FIG. 3 illustrates sample tennis singles match grammar utilized to generate input parser according to an embodiment of the present invention;

FIG. 4 provides sample terminal token definitions for a voice input mode of recording for use in conjunction with tennis match grammar according to an embodiment of the present invention;

FIG. 5 illustrates sample terminal token definitions for a telephone keypad input mode of recording for use in conjunction with tennis match grammar according to an embodiment of the present invention;

FIG. 6 illustrates a sample match high-level information report according to an embodiment of the present invention;

FIG. 7 illustrates a sample graphical representation of a foreground stroke analysis report for a left-handed player according to an embodiment of the present invention;

FIG. 8 illustrates a sample database schema for storing stroke and point information according to an embodiment of the present invention; and

FIG. 9 illustrates a sample of voice notation for recording singles tennis matches according to an embodiment of the present invention.

### DETAILED DESCRIPTION

According to an embodiment of the present invention, a person observing a game enters a game progression via a telephone device, such as a cellular telephone or a landline (wired or cordless) telephone. The game may be observed live, or from a previously recorded media.

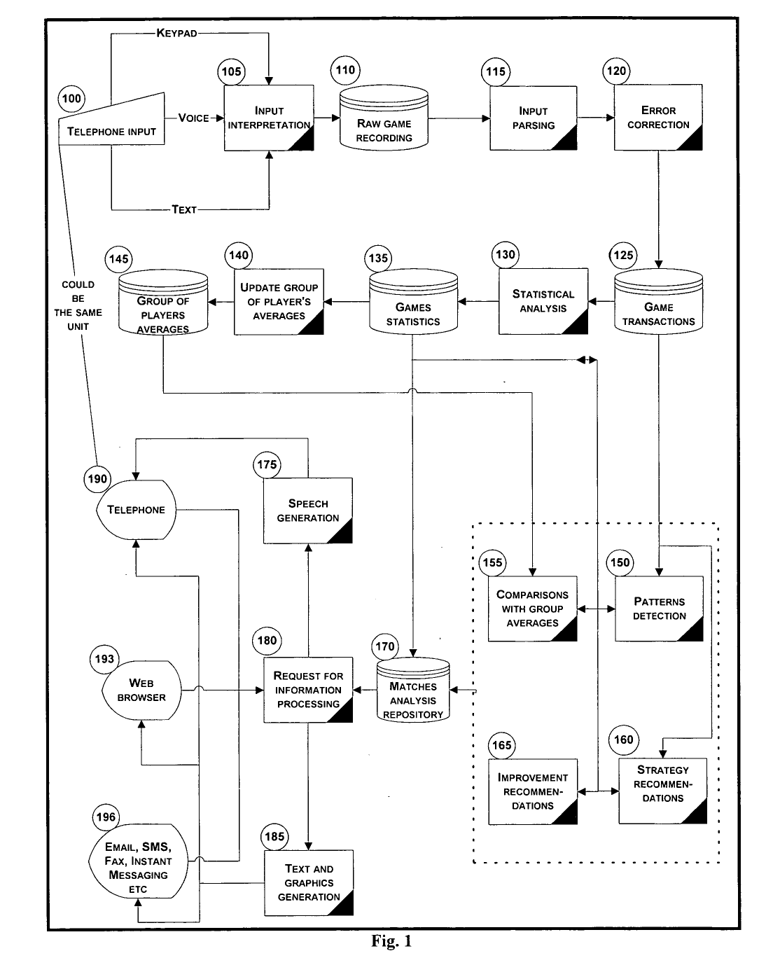

FIG. 1 provides a block diagram of process components involved in delivery of game analysis services according to an embodiment of the present invention. According to one embodiment of the present invention, an observer calls a telephone number to establish a connection with an input interpretation module 105 of the system. The observer provides information about the match and players into the input interpretation module 105 via, for example, menu driven interactions using voice and/or keypad entries, utilizing, for example, dual tone multi-frequency (DTMF) signals, or any other suitable signal types. Some examples of tennis match information may include: indoor/outdoor venue, type of surface, lighting, wind conditions, match format, etc.; and the players' information may include: names, IDs, gender, left or right handed, skill level, etc. The game progression may be entered using standard telephone keypad keys or via voice commands using a telephone 100. For example, one may speak the following sequence of utterances for a play: “player 1, serve, down the line, let, serve, cross court, error long, serve, center, forehand ground, backhand volley, lob, winner, score 30 15, etc.” Alternatively, one may enter a sequence of keypad entries that correspond to the above utterances (described further below).

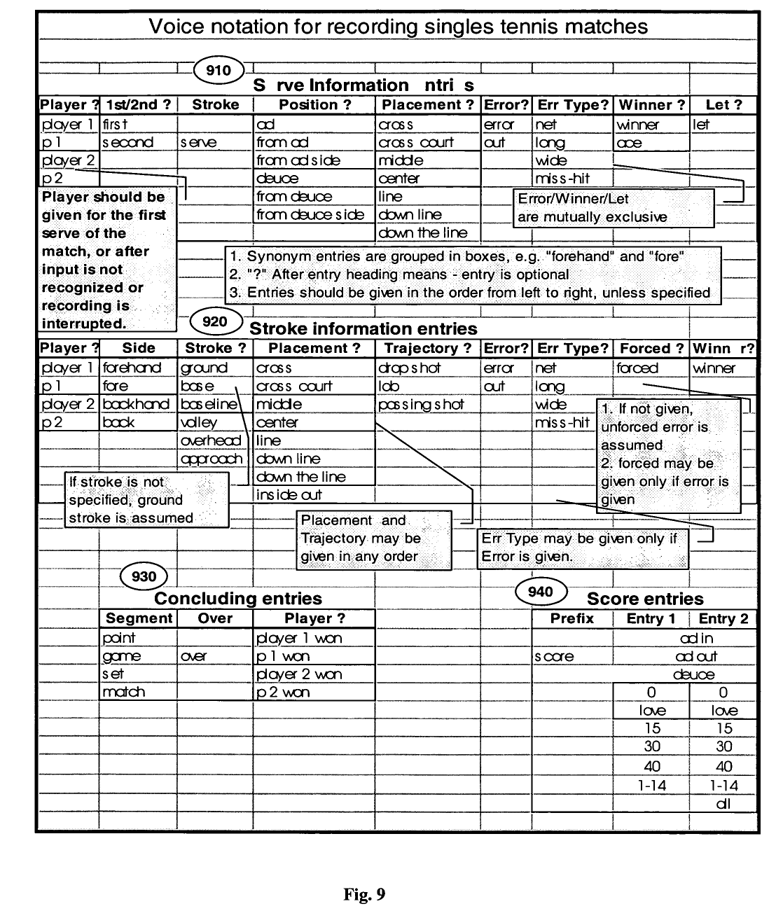

FIG. 9 illustrates a sample of voice notation for recording singles tennis matches according to an embodiment of the present invention. Table 910 provides sample recognized voice utterances for describing serve strokes. Table 920 provides sample voice encoding for all other strokes. Table 930 provides sample segments concluding entries, and table 940 provides encoding for entering score entries.

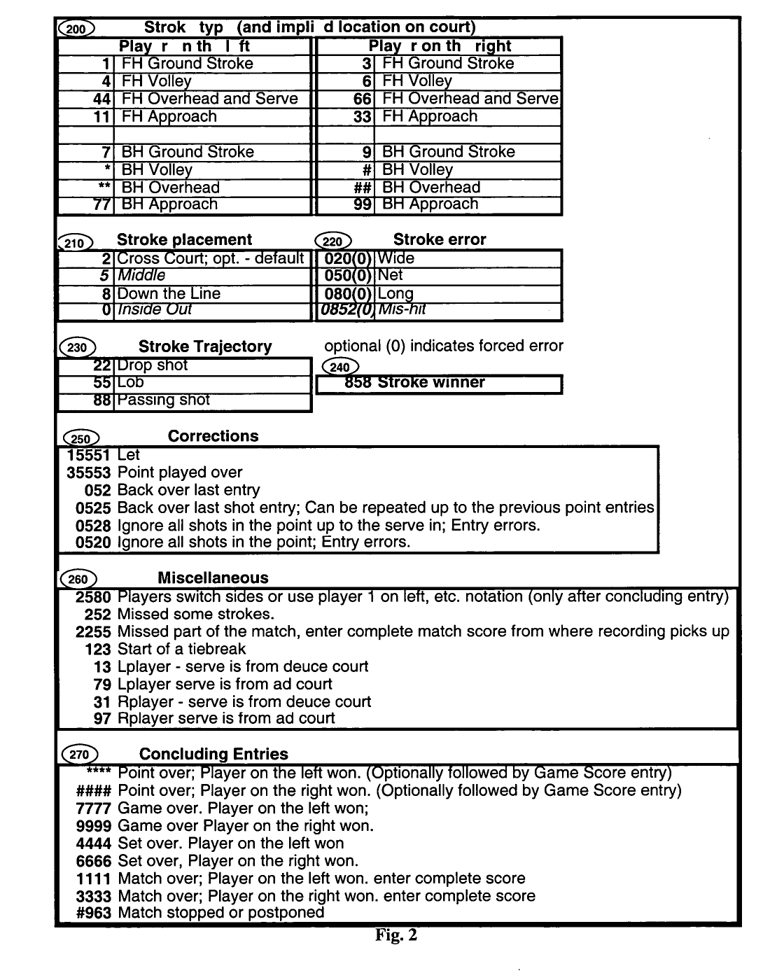

FIG. 2 illustrates sample telephone keypad key encodings for a singles tennis match according to an embodiment of the present invention. Table 200 provides encoding for stroke types; table 210 provides encoding for stroke placement; table 220 provides encoding for stroke errors; table 230 provides encoding for stroke trajectories; table 240 provides encoding for a stroke winner; table 250 provides encoding for various corrections; table 260 provides miscellaneous entries, such as indicating player locations on the court, missing parts of recording, etc.; and table 270 provides encoding for point, game, set and match concluding entries. For example, the following is a telephone keypad key sequence for encoding the above mentioned game sequence “left, serve, down the line, let, serve, cross court, error long, serve, center, forehand ground, backhand volley, lob, winner, score 30 15” utilizing the tables of FIG. 2: “44 8 15551 44 2 080 44 5 3*55****30 15”, where the spaces are shown here for readability.

In one mode of operation according to an embodiment of the present invention, a third party observing a game may enter a game progression either using keypad entries or voice. In another mode of operation according to an embodiment of the present invention, a player participating in a game may, for example, enter a game progression utilizing a cell phone with a headset during matches. This mode of operation may allow a teaching professional, for example, to enter a game progression, or progression of a training session with a student.

Information may be recorded for just one player or all players in a match. One may record just the opening and concluding shots of every point, or choose to record every single shot played. Also, depending on the speed of the game and the number of players being recorded, additional information may be provided. For example, stroke placement and trajectory, as well as stroke spin and power characteristics may be entered. If information about opponents is entered, it enables more detailed analysis about strategies. Additional information about stroke placement enables more detailed analysis of strokes for a player. The method also allows for the score information to be entered for each point, game, set and match.

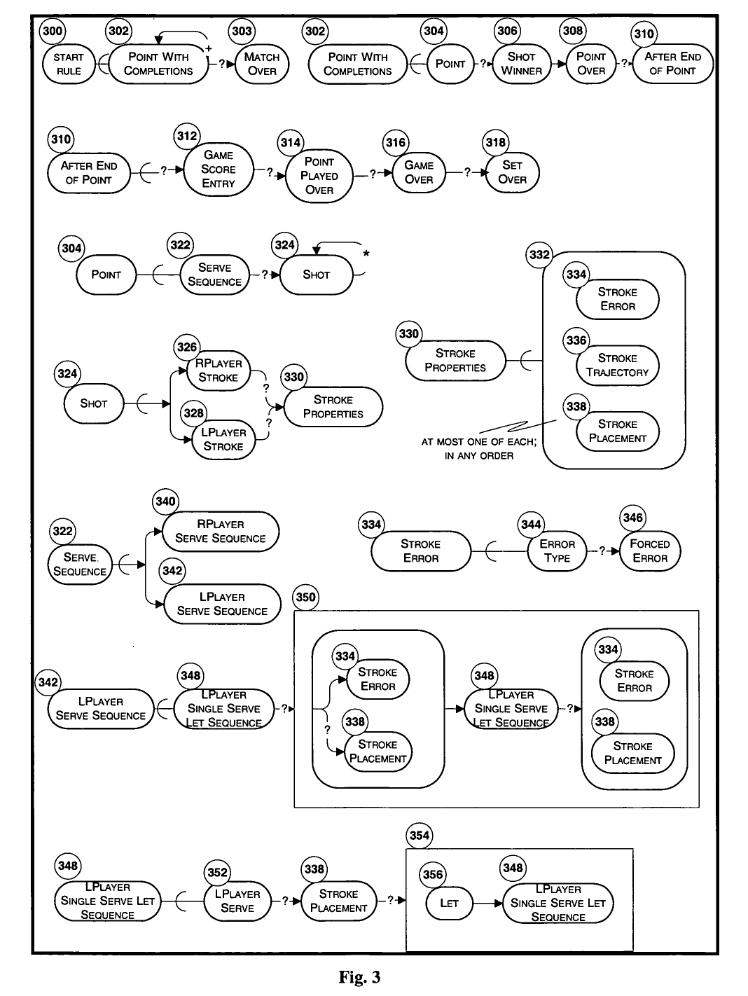

Referring back to FIG. 1, the input interpretation module 105 interprets telephone input data and saves it into a raw game recording database 110. An input parsing module 115 extracts data from the raw game recording database 110. The input parsing module 115 may utilize match grammar, a sample of which that may be implemented is illustrated in FIG. 3. However, any other suitable match grammar may also be utilized.

Referring to FIG. 3, tennis match definitions start at block 300. The tennis match is defined as a Point with Completions 302 repeated one or more times and followed by a Match Over 303. Point with Completions 302 is defined as a Point 304, optionally followed by a Shot Winner 306, followed by a Point Over 308, and then optionally followed by an After End of Point 310. An After End of Point 310 is defined as optional Game Score Entry 312, optionally followed by a Point Played Over 314, optionally followed by a Game Over 316, and finally optionally followed by a Set Over 318. Point 304 is defined as a Serve Sequence 322, optionally followed by Shots 324. A Shot 324 is defined as a Right Player Stroke 326 or a Left Player Stroke 328, optionally followed by Stroke Properties 330. Stroke Properties 330 are defined as a sequence 332 of Stroke Error 334, a Stroke Trajectory 336, and a Stroke Placement 338 provided in arbitrary order. Serve Sequence 322 is defined as a Right Player Serve Sequence 340 or a Left Player Serve Sequence 342. Left Player Serve Sequence 342 is defined as Left Player Single Serve Let Sequence 348, optionally followed by block 350. Block 350 is defined as optional Stroke Placement 338 with mandatory Stroke Error 334 provided in arbitrary order, followed by a Left Player Single Serve Let Sequence 348, optionally followed by Stroke Error 334 and Stroke Placement 338 provided in arbitrary order. Stroke Error 334 is defined as an Error Type 344, optionally followed by a Forced Error 346. Left Player Single Serve Let Sequence 348 is defined as a Left Player Serve 352, optionally followed by a Stroke Placement 338, optionally followed by a sequence 354 consisting of Let 356 and recursively Left Player Single Serve Let Sequence 348. Right Player Serve Sequence may be defined in a similar fashion. A sample of the textual form of the grammar is provided below as Table A. Accordingly to one embodiment of the present invention, FIG. 3 formally defines all of the possible legal sequences of tennis match descriptions in terms that are familiar to a tennis player as described in FIG. 9. However, in alternative embodiments of the present invention, other possible legal sequences of tennis matches, or other events, may be implemented. For example, it is possible to define training session sequences that correspond to specific practice drills.

TABLE A
TENNIS MATCH PARTIAL GRAMMAR

| | |
|---|---|
| startrule: PointWithCompletion(s) | StrokePlacementWithError: |
| MatchOver | ( StrokeError StrokePlacement(?) ) |
| PointWithCompletion: | \| ( StrokePlacement StrokeError ) |
| Point ShotWinner(?) | StrokePlacementAndError: |
| PointOver AfterEndOfPoint | ( StrokeError(?) StrokePlacement(?) ) |
| AfterEndOfPoint: | \| ( StrokePlacement(?) |
| ( GameScoreEntry(?) | StrokeError(?) ) |
| PointPlayedOver(?) ) | StrokePropertiesWithError: |
| GameOver(?) SetOver(?) | ( StrokeError |
| Point: | StrokePlacementAndTrajectory ) |
| ServeSequence Shot(s?) | \| ( StrokeTrajectory(?) |
| Shot: | StrokeError StrokePlacement(?) ) |
| ( RPlayerStroke \| LPlayerStroke ) | \| ( StrokePlacement(?) |
| StrokeProperties(?) | StrokeError StrokeTrajectory(?) ) |
| StrokeProperties: | \| ( StrokePlacementAndTrajectory |
| ( StrokeError( ( StrokePlace- | StrokeError ) |
| ment(?) StrokeTrajectory(?) ) | ServeSequence: |
| \| ( StrokeTrajectory(?) | LPlayerServeSequence \| |
| StrokePlacement(?) ))) | RPlayerServeSequence |
| \| ( StrokePlacement | LPlayerServeSequence: |
| (( StrokeTrajectory(?) | LPlayerSingleServeLetSequence['1'] |
| StrokeError(?) ) | ( StrokePlacementWithError |
| \| ( StrokeError(?) | LPlayerSingleServeLetSequence['2'] |
| StrokeTrajectory(?) ))) | StrokePlacementAndError(?) )(?) |
| \| ( StrokeTrajectory ( | LPlayerSingleServeLetSequence |
| ( StrokeError(?) | (serveN): |
| StrokePlacement(?) ) | LPlayerServe[$serveN] StrokePlace- |
| \| ( StrokePlacement(?) | ment(?) |
| StrokeError(?) ))) | (Let LPlayerSingleServeLetSe- |
| StrokeError: | quence[serveN])(?)) |
| ( ErrorType ForcedError(?) ) | RPlayerServeSequence: |
| StrokePlacementAndTrajectory: | #like LPlayerSequence |
| ( StrokePlacement(?) | GameScoreEntry: |
| StrokeTrajectory(?) ) | (RegularGameScoreEntry \| |
| \| ( StrokeTrajectory(?) | TieBreakScoreEntry) |
| StrokePlacement(?)) | EndOfScoreEntry |

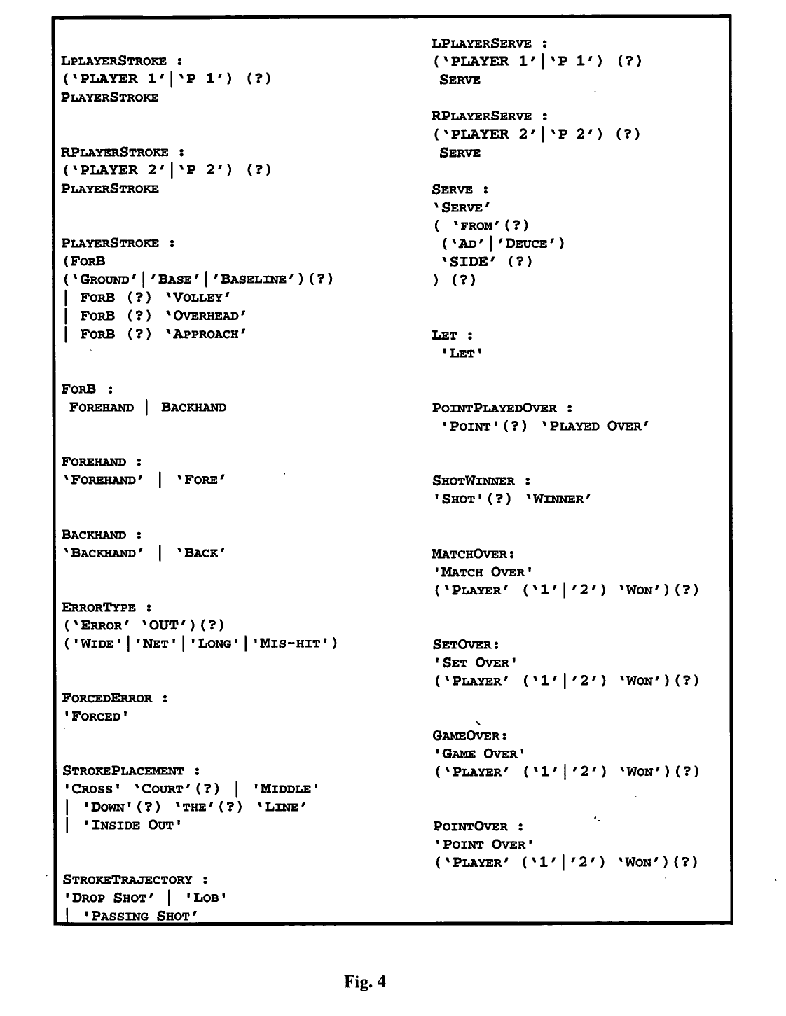

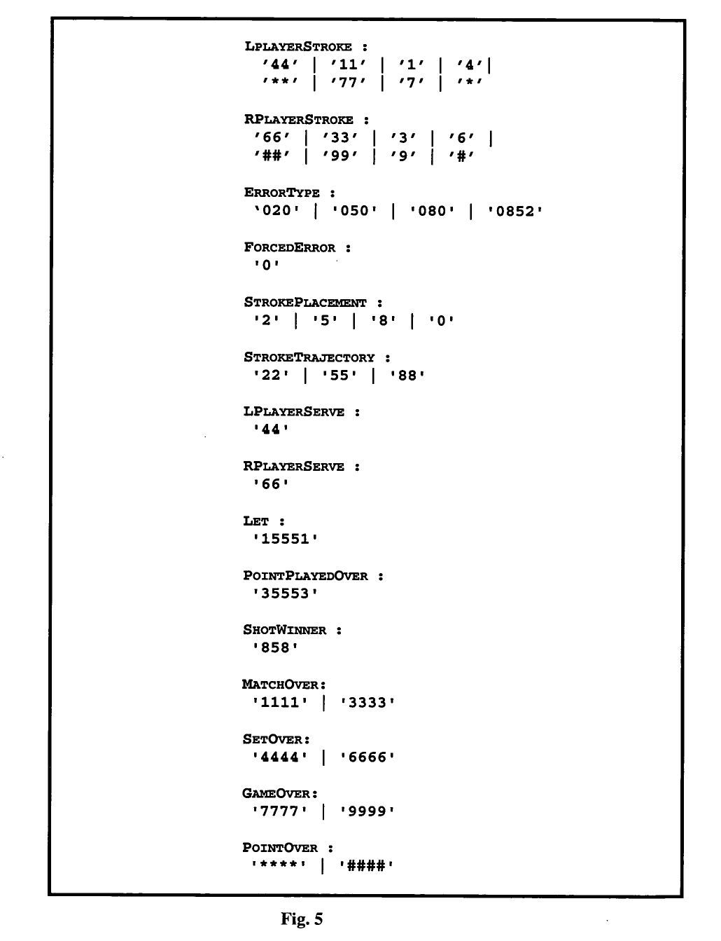

The match grammar, in conjunction with the definition of the terminal symbols, is utilized to automatically generate a program for input parsing. FIG. 4 provides sample terminal token definitions for a voice input mode of recording for use in conjunction with tennis match grammar according to an embodiment of the present invention, and FIG. 5 illustrates sample terminal token definitions for a telephone keypad input mode of recording for use in conjunction with tennis match grammar according to an embodiment of the present invention. With the help of an error correction module 120 (see FIG. 1), the input parsing module 115 produces detailed game transaction records logged into a game transactions database 125 registering entered information about every stroke and point in the game. For example, the system may keep the following information for every stroke-player reference: stroke type, forehand or backhand, stroke placement, trajectory, was it a let, was it a winner or error shot, if error, was it a forced error, etc.

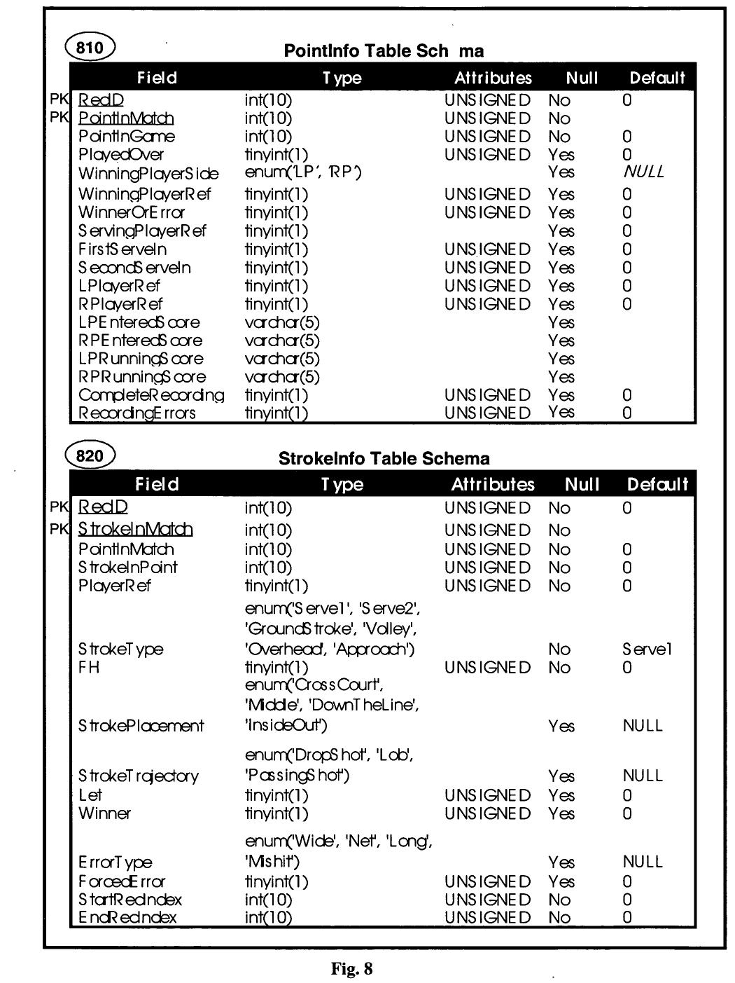

FIG. 8 illustrates a sample database schema for storing stroke and point information according to an embodiment of the present invention. Sample table schemas for PointInfo 810 and for Strokelnfo 820 tables list field names, field types and attributes, values for enumerated fields, primary keys, and default values for the fields. For example, the Strokelnfo 820 table composite primary key consists of a RecID (record identification) field and StrokeInMatch (stroke number in the match) field. For the StrokePlacement field, it lists legal enumerated values as “CrossCourt”, “Middle”, “DownTheLine” and “InsideOut”. The Strokelnfo 820 table further indicates that NULL value is allowed for this field and NULL is the default value, if no explicit value is given.

The input processing mechanism may be designed to be forgiving of input errors. For a fast paced match, there is frequently no time to request correction of data entry errors in real time from a user. The system attempts to recover from the input mistakes whenever possible and when it is not possible, the transactional entries are marked as erroneous. For example, the system may allow a user to enter erroneously a serve from the wrong side of the court, processing the rest of the input sequence to maintain the game's pace. The system may attempt to fix the error automatically, for example, if it can be determined contextually, based on the subsequent input, that the serve in the correct progression of the game would have to have been performed from the other side.

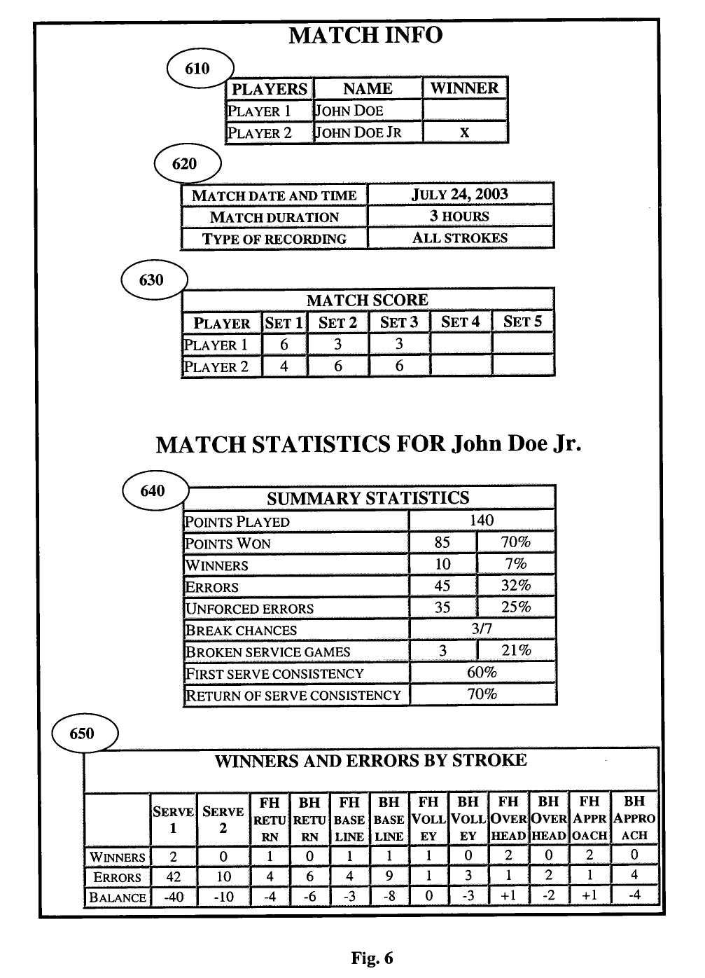

Referring back to FIG. 1, a statistical analysis module 130 produces detailed game statistics and stores it into a games statistics database 135 using information from the game transactions database 125. FIG. 6 illustrates a sample match high-level information report according to an embodiment of the present invention. Table 610 provides player names and indicates the winner. Table 620 provides match and recording type information. Table 630 provides match score by set. Table 640 provides summary match statistics. Table 650 provides a breakdown of winners versus errors report by stroke type. The system may calculate hundreds of statistical values about every aspect of the game, such as scoring characterization, player performance characterization, team performance characterization, temporal-based performance characterization, location-based performance characterization, and objects of the game-based performance characterization. Other statistical values and aspects of the game not mentioned above may also be calculated.

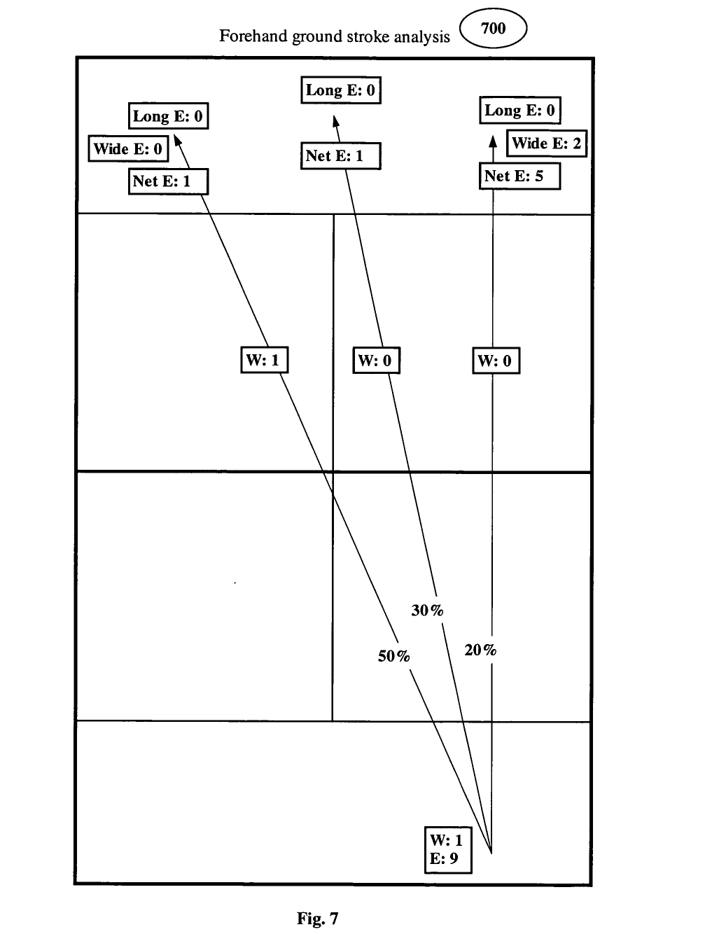

For example, for every player, the system may calculate percent of first serves in from deuce side, number of aces serving wide from ad side, number of winner and errors, return of serve consistency from the backhand side, points won when the first serve was in, etc. FIG. 7 illustrates a sample graphical representation of a foreground stroke analysis report for a left-handed player according to an embodiment of the present invention. The report 700 illustrates that there were nine errors versus one winner for this stroke. Additionally, 50% of strokes were hit cross court, 30% in the center, and 20% were placed down the line. The only winning shot was hit cross court. The report 700 further provides the breakdown of errors by stroke placement, indicating that there was one error into the net for each of the cross-court and center placed shots. There were two errors wide, five errors into the net for down the line placed forehand ground strokes.

Referring back to FIG. 1, an update group of players' averages module 140 updates a group of players' averages (or team averages) and stores it into a group of players' averages database 145 using information from the games statistics database 135.

A patterns detection module 150 detects repeated patterns of player behavior. Patterns of behavior are defined as statistically significant events or comparisons. Patterns may be defined as triggering events. The level of significance may be set individually for each pattern. Patterns involve comparisons of statistical analysis values derived by the statistical analysis module 130 (game analysis records), as well as direct analysis of game transaction record from the game transactions database 125. Patterns involve temporal and location-based characterization of players, teams, and objects of the game. For example, Player 1 comes to the net immediately after the serve; Player 2 hits at least two shots cross-court from the forehand side before hitting down the line.

An improvement recommendations module 165 provides recommendations for improvement. For example, “Player 1's current first serve percentage is 90%. Player 1 can safely increase the speed of the first serve bringing the first serve percentage to the 70%-80% range, providing a better chance of winning serve points.” Here are two more examples: “Player 2's backhand volley consistency was 35%. Player 2 needs to work on improving the backhand volleys.” “Most players at the next level of proficiency have a ‘weapon’ shot leading to a high percentage of winning shots. Player needs to work on developing such a weapon stroke.”

A strategy recommendation module 160 provides strategy recommendations for playing against a specific opponent. For example, “long rallies you win 75% of the time—do not over hit, just stay in the rallies. 90% of the serves of your opponent from the deuce court are to your forehand. None of the serves to your backhand were aces or return errors. You may want to move just a bit more to your forehand side while receiving the serve.”

A comparisons with group averages module 155 provides comparison of your statistics (or of another player) against average statistics of a group of players (or team averages). For example, “your backhand ground stroke consistency is well below the average consistency of players at your level”, or “your volley consistency is well above the average consistency of the players at your level.”

Information from the game statistics module 135, pattern detection module 150, comparisons with group averages module 155, strategies recommendations module 160, and improvement recommendations module 165 is deposited into a matches analysis repository 170. Devices providing telephone 190, Web browser 193, and textual transmissions 196 capabilities may send requests for various match information pieces to a request for information processing module 180. For example, one could request a short or expanded statistical report, report by sets, just serve statistics, comparison to averages report, strategy recommendations, etc. The request for information processing module 180 collects information from the matches analysis repository 170 and directs a speech generation module 175 or a text and/or graphics generation module 185 to generate the appropriate response to the requesting module 190, 193 or 196 rendering of the information in voice, graphics, animation, and/or textual form, passing the information to devices supporting voice 190 and/or text and/or graphics 193 or 196 capabilities such as e-mail, Web page reports, pagers, short message service (SMS), fax, instant messaging, etc.

A Web browser 193 may reside on any device such as a computer or even on a cell phone equipped with Web browsing capabilities. Similarly, e-mail, paging, SMS, instant messaging, fax, or any other suitable data transmissions may be delivered to any device supporting such service(s), even through the same cellular telephone that was utilized for data entry of a game progression. Information may be delivered using “push” or “pull” technology. Delivery may be performed during a match, updating information after every set, or when some statistically significant changes in the running averages occur.

A user of the telephone input 100 may issue a command to record unparsed voice utterances that are captured by the input interpretation module 105 and stored in the raw game recording database 110. Such unparsed voice utterances may represent comments, insights, or recommendations, and are keyed by the segment of the game when they are made. Recorded comments may be related to the individual strokes or point progression, or may represent comments on the overall game. For example, an observer may provide information regarding the depth of a stroke or strokes, change in the movement pattern of a player, information regarding position of a player on court, recommendations on shot selection, comments regarding demeanor on court, appearance of signs of player injury, change in weather conditions, etc. Recorded comments may represent observations about the game or training session that are not captured via the parsed recording format. These comments may be made available for review via devices that support playback, for example, such as a telephone 190 and a Web browser 193.

Telephone input 100 may be provided by the same device as the telephone 190 for receiving data, as discussed above. Alternatively, the telephone input 100 may be provided by a different device and person as well. Also, there may be multiple telephone devices 190, Web browser devices 193, and text/graphics devices 196 receiving information simultaneously. This mode of operation enables many spectators watching a match to access match statistics and match analysis information all at the same time.

Accordingly to one alternative embodiment of the present invention, the telephone input 100 may be provided via a digital mode of telephone connectivity, such as via a Web browser, SMS, email, I-mode (NTT DoCoMo mobile Internet access system), wireless application protocol (WAP), or via instant messaging. Telephone input 100 may be performed using special keys and buttons on a phone, such as a navigation joystick, up-and-down navigation keys, an alpha-(numeric) keypad, a touch-sensitive screen, etc. Telephone input 100 may be provided in a mixed mode of communication using voice and telephone keys (or other manual input) as well. The system may allow for a user of the telephone input 100 to select a language to be used for data entry, when appropriate. The voice recognition may be performed by speaker-independent or speaker-dependent speech recognition engines. Also, a speaker may pre-record custom utterances that may be utilized by the recognition engine.

According to yet another embodiment of the present invention, for telephones equipped with programming capabilities, (e.g., Java 2 Platform Enterprise Edition (J2EE) capable phones), the input interpretation module 105 for processing keypad and text entries may be carried out via a custom program residing on the telephone. In a case where the telephone has capabilities for speech recognition and programming capabilities, the input interpretation module 105 for processing voice entries may be carried out by the telephone as well. Similarly, any portion of the further processing steps (see FIG. 1) from the raw game recording storage 110 to the text and graphics generation 185 may be carried out on a telephone capable of carrying out such computations or on a similarly-equipped device.

The described analysis capabilities may be performed on any off-the-shelf device (e.g., mobile phones, PDAs, laptops, etc.), either “dumb” or “smart”, distributing the described processing between the device and the back-end system to achieve the most economical solution to the user, taking into account the costs of custom program development, communication costs, and the costs of performing back-end processing. The notion of the most economical solution will change over time as penetration of “smart” phones and devices increases, and communication costs of voice and data connections change.

According to one embodiment of the present invention, the telephone input 100 may encompass the input interpretation module 105, the input parsing module 115, and the error correction module 120 capabilities on the phone or on a similarly-equipped device itself. It may be also possible to provide some of the “further down the line” processing functions (see FIG. 1) on the telephone device. In one specific embodiment of the present invention, all processing functions may be carried out on the communication device itself. Match recording and analysis may be performed without establishing connectivity with a back-end system. At some later point in time, such device may connect to a remote system to store the recorded games and data, to obtain updates of statistical averages, to obtain patterns extracted from the analysis of a larger set of recorded matches, and to update strategy recommendation rules or other customization information.

As discussed above, it may also be possible to utilize an alternative communication device instead of a telephone, such as an e-mailer (e.g., a Blackberry), paging device, or any other device enabling transmission/connectivity capabilities.

Targeted advertisements may also be delivered to the device utilized for entering or receiving the information as part of providing the service.

The same methodology may apply for the construction of systems allowing spectators to access game statistics and analysis information.

According to another embodiment of the present invention, multiple players or observers of an event may enter game progression simultaneously for a partial game progression as it relates to the actions of only some of the players. Partial game progressions may allow users to enter more detailed information about the game, and the complete game action is reconstructed by combining time stamped inputs from multiple recording streams. For example, each player in a doubles match may record their own strokes using separate input devices utilizing voice input; or two observers may enter information only for one of the opposing teams.

According to another embodiment of the present invention, tabulation of game statistics may be performed directly without creating database entries for individual stroke entries.

According to yet another embodiment of the present invention, multiple spectators of an event may enter game progression simultaneously, potentially competing for a prize. Data entries may be judged based on the accuracy and completeness of the recordings. This mode of operation allows obtaining higher fidelity game depictions based on the averages of the inputs.

In yet another embodiment of the present invention, voice input describing a match may be stored in the input device and then transferred to the back-end system for processing. Such transfer may be performed manually at the end of a match by taking, for example, a removable media and moving it to the processing system in a digital (e.g., memory card, etc.) or an analog form (e.g., tape). Furthermore, digitally stored recordings may be transferred to the back-end system at some later point in time via, for example, a digital communication connection. Alternatively, voice input also may be digitized and streamed to the back-end system as data without storing it on the input device.

Similar methodologies may apply to the construction of systems for the analysis of other sports activities, and is thus not limited to that of only tennis. Additionally, observations of other events, including other sports and non-sporting events, may also be recorded utilizing embodiments of the present invention.

Accordingly to embodiments of the present invention, analysis of sports activities, for example, may be delivered without the need for additional software purchases or downloads, or specialized hardware purchases by the end user. The service is available for anybody with access to a standard telephone, and most conveniently any wireless telephone, such as a cellular phone, without imposing any additional equipment requirements. The players themselves are provided the ability to enter the game progression in real-time, while playing a game. A tennis coach may enter the game progression or training session progression while playing or feeding the ball to a student player. Additionally, there is no need to look away from the observed game to enter game information when voice input is used, or the game progression may be entered utilizing the familiar telephone keypad keys layout, not requiring taking one's eyes away from the game to enter the game information. A player or a tennis coach may receive match statistics and recommendations in real-time during friendly matches or coaching sessions, via a headset connected to a telephone via a wire or wirelessly. Player (and/or team) statistics may be compared to the averages of a group of players (team) at an equivalent skill level of play. Embodiments of the present invention may also provide the ability to deliver recommendations for player improvement based on the comparison with the averages of players at the same or higher skill level. An observer, a player or a coach may record comments, insights, or recommendations during the match recording. Recorded voice segments are made available for playback during the review via telephone, Web site, or any other means of access that support audio. Spectators may have the ability to receive match statistics while watching a match via a telephone or other device supporting Web browsing, e-mail, SMS, or other means of transmitting information. And, embodiments of the present invention provide an infrastructure for delivering continuously improving custom recommendations for the players without the need for software or hardware upgrades at the user end.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

1. A method of performing and delivering analysis of a sports activity, comprising:
providing input via a communication device of a user;
interpreting the input provided by the user;
creating a transactional record of the sports activity based on the input provided by the user;
analyzing the transactional record of the sports activity to generate analysis information of the sports activity;
receiving a request for the analysis information of the sports activity; and
providing the analysis information of the sports activity to a requester.

2. The method of claim 1, further including storing the analysis information of the sports activity in an analysis information database.

3. The method of claim 1, wherein the requester is the user.

4. The method of claim 1, wherein the analysis information is provided to the user via voice, graphics, animation, or textual form.

5. The method of claim 1, wherein interpreting the input provided by the user includes at least one of interpreting voice input, and interpreting communication device input entries.

6. The method of claim 5, wherein interpreting voice input utilizes at least one of: a speaker-independent speech recognition engine, a speaker-dependent speech recognition engine, and a speaker pre-recorded custom utterances recognition engine.

7. The method of claim 1, wherein creating the transactional record of the sports activity includes parsing the input provided by the user and performing error correction on the input provided by the user based on at least one of a predefined vocabulary and grammar for user communication, and a free-form natural language interpretation grammar.

8. The method of claim 7, wherein the free-form natural language interpretation grammar is statistical language model (SLM) grammar.

9. The method of claim 1, further including at least one of: performing statistical analysis of the sports activity, performing pattern detection on the transactional record of the sports activity, creating strategy recommendations for participants in the sports activity, creating improvement recommendations for the participants in the sports activity, and providing comparisons of the statistical analysis of the sports activity with a group of players' averages or team averages for the sports activity.

10. The method of claim 1, wherein analyzing the transactional record of the sports activity to generate the analysis information of the sports activity includes at least one of: scoring characterization, player performance characterization, team performance characterization, temporal-based performance characterization, location-based performance characterization, and objects of the game-based performance characterization.

11. The method of claim 9, wherein performing pattern detection on the transactional record of the sports activity includes:
describing a pattern by defining a triggering event in terms of at least one of game transaction records and game analysis records; and
defining a statistical significance level for triggering the pattern.

12. The method of claim 1, wherein providing the analysis information of the sports activity to the requester includes at least one of: instantaneously delivering the analysis information at a time of request, delivering the analysis information at predetermined intervals of time from the time of request, delivering the analysis information at a predetermined point in a game, delivering the analysis information when the game pauses, delivering the analysis information at points of significant changes in statistics during a game progression, and delivering the analysis information after the game completion.

13. The method of claim 1, wherein providing the analysis information of the sports activity to the requester includes:
calculating temporal statistics of game periods;
establishing significance level thresholds for comparisons of game statistics between the game periods;
detecting when the significance level thresholds are exceeded; and
logging the exceeded significance level thresholds for delivery to the user.

14. The method of claim 1, wherein the analysis information of the sports activity is provided to a plurality of requesters.

15. The method of claim 1, wherein providing the analysis information of the sports activity to the requester includes providing an advertisement along with the analysis information of the sports activity.

16. The method of claim 1, wherein a plurality of communication devices of a plurality of users provide the input.

17. The method of claim 16, further including:
comparing the inputs from the plurality of users; and
rewarding the users based on the inputs received.

18. The method of claim 16, further including:
time-stamping each of the inputs received from each of the plurality of communication devices; and
reconstructing a game progression based on a conglomeration of the inputs from the plurality of communication devices.

19. A method of performing and delivering analysis of an activity, comprising:
receiving input from a communication device of a user;
processing the input provided by the user;
generating analysis information of the activity based on the input provided by the user; and
providing the analysis information of the activity to a requester.

20. The method of claim 19, further including:
generating a transactional record of the activity based on the input provided by the user; and
analyzing the transactional record of the activity to generate the analysis information of the activity.

21. The method of claim 19, wherein the activity is a sports activity.

22. The method of claim 19, further including storing the analysis information of the activity in an analysis information database.

23. The method of claim 19, wherein the requester is the user.

24. The method of claim 19, wherein the analysis information is provided to the user via voice, graphics, animation, or textual form.

25. The method of claim 19, wherein processing the input provided by the user includes at least one of interpreting voice input, and interpreting communication device input entries.

26. The method of claim 25, wherein interpreting the voice input utilizes at least one of: a speaker-independent speech recognition engine, a speaker-dependent speech recognition engine, and a speaker pre-recorded custom utterances recognition engine.

27. The method of claim 20, wherein generating the transactional record of the activity includes parsing the input provided by the user and performing error correction on the input provided by the user based on at least one of a predefined vocabulary and grammar for user communication, and a free-form natural language interpretation grammar.

28. The method of claim 27, wherein the free-form natural language interpretation grammar is statistical language model (SLM) grammar.

29. The method of claim 19, further including at least one of: performing statistical analysis of the activity, performing pattern detection on a transactional record of the activity, creating strategy recommendations for participants in the activity, creating improvement recommendations for the participants in the activity, and providing comparisons of statistical analysis of a participant's activity with a group of participants' averages or team averages for the activity.

30. The method of claim 20, wherein analyzing the transactional record of the activity to generate the analysis information of the activity includes at least one of: scoring characterization, participant performance characterization, group of participants performance characterization, temporal-based performance characterization, location-based performance characterization, and objects of the activity-based performance characterization.

31. The method of claim 29, wherein performing pattern detection on the transactional record of the activity includes:
describing a pattern by defining a triggering event in terms of at least one of activity transaction records and activity analysis records; and
defining a statistical significance level for triggering the pattern.

32. The method of claim 19, wherein providing the analysis information of the activity to the requester includes at least one of: instantaneously delivering the analysis information at a time of request, delivering the analysis information at predetermined intervals of time from the time of request, delivering the analysis information at a predetermined point in an activity, delivering the analysis information when the activity pauses, delivering the analysis information at points of significant changes in statistics during an activity progression, and delivering the analysis information after the activity completion.

33. The method of claim 19, wherein providing the analysis information of the activity to the requester includes:
calculating temporal statistics of activity periods;
establishing significance level thresholds for comparisons of activity statistics between the activity periods;
detecting when the significance level thresholds are exceeded; and
logging the exceeded significance level thresholds for delivery to the user.

34. The method of claim 19, wherein the analysis information of the activity is provided to a plurality of requesters.

35. The method of claim 19, wherein providing the analysis information of the activity to the requester includes providing an advertisement along with the analysis information of the activity.

36. The method of claim 19, wherein a plurality of communication devices of a plurality of users provide the input.

37. The method of claim 36, further including:
comparing the inputs from the plurality of users; and
rewarding the users based on the inputs received.

38. The method of claim 36, further including:
time-stamping each of the inputs received from each of the plurality of communication devices; and
reconstructing an activity progression based on a conglomeration of the inputs from the plurality of communication devices.

39. A program code storage device, comprising:
a machine-readable medium; and
machine-readable program code stored on the machine-readable medium, the machine-readable program code having instructions to
receive input relating to an activity from a communication device of a user;
process the input provided by the user;
generate analysis information of the activity based on the input provided by the user; and
provide the analysis information of the activity to a requester.

40. The program code storage device of claim 39, wherein the machine-readable program code further includes instructions to:
generate a transactional record of the activity based on the input provided by the user; and
analyze the transactional record of the activity to generate the analysis information of the activity.

41. The program code storage device of claim 39, wherein the activity is a sports activity.

42. The program code storage device of claim 39, wherein the requester is the user.

43. The program code storage device of claim 39, wherein the analysis information is provided to the user via voice, graphics, animation, or textual form.

44. The program code storage device of claim 39, wherein the instructions to process the input provided by the user include at least one of instructions to interpret voice input, and instructions to interpret communication device input entries.

45. The program code storage device of claim 44, wherein the instructions to interpret voice input utilizes at least one of: a speaker-independent speech recognition engine, a speaker-dependent speech recognition engine, and a speaker pre-recorded custom utterances recognition engine.

46. The program code storage device of claim 40, wherein the instructions to generate the transactional record of the activity include instructions to parse the input provided by the user and instructions to perform error correction on the input provided by the user based on at least one of a predefined vocabulary and grammar for user communication, and a free-form natural language interpretation grammar.

47. The program code storage device of claim 46, wherein the free-form natural language interpretation grammar is statistical language model (SLM) grammar.

48. The program code storage device of claim 39, wherein the machine-readable program code further includes at least one of instructions to: perform statistical analysis of the activity, perform pattern detection on a transactional record of the activity, create strategy recommendations for participants in the activity, create improvement recommendations for the participants in the activity, and provide comparisons of statistical analysis of the activity with a group of participants' averages or team averages for the activity.

49. The program code storage device of claim 40, wherein the instructions to analyze the transactional record of the activity to generate the analysis information of the activity include at least one of instructions to perform: scoring characterization, participant performance characterization, team performance characterization, temporal-based performance characterization, location-based performance characterization, and objects of the activity-based performance characterization.

50. The program code storage device of claim 48, wherein the instructions to perform pattern detection on the transactional record of the activity include instructions to:
describe a pattern by defining a triggering event in terms of at least one of activity transaction records and activity analysis records; and
define a statistical significance level for triggering the pattern.

51. The program code storage device of claim 39, wherein the instructions to provide the analysis information of the activity to the requester include at least one of instructions to: instantaneously deliver the analysis information at a time of request, deliver the analysis information at predetermined intervals of time from the time of request, deliver the analysis information at a predetermined point in an activity, deliver the analysis information when the activity pauses, deliver the analysis information at points of significant changes in statistics during an activity progression, and deliver the analysis information after the activity completion.

52. The program code storage device of claim 39, wherein the instructions to provide the analysis information of the activity to the requester include instructions to:
calculate temporal statistics of activity periods;
establish significance level thresholds for comparisons of activity statistics between the activity periods;
detect when the significance level thresholds are exceeded; and
log the exceeded significance level thresholds for delivery to the user.

53. The program code storage device of claim 39, wherein the analysis information of the activity is provided to a plurality of requestors.

54. The program code storage device of claim 39, wherein the instructions to provide the analysis information of the activity to the requester include instructions to provide an advertisement along with the analysis information of the activity.

55. The program code storage device of claim 39, wherein a plurality of communication devices of a plurality of users provide the input.

56. The program code storage device of claim 55, further including instructions to:
compare the inputs from the plurality of users; and
reward the users based on the inputs received.

57. The program code storage device of claim 55, further including instructions to:
time-stamp each of the inputs received from each of the plurality of communication devices; and
reconstruct an activity progression based on a conglomeration of the inputs from the plurality of communication devices.

58. A system for performing and delivering analysis of an activity; comprising:
a receiver to receive input from a communication device of a user;
a processing unit to process the input provided by the user and to generate analysis information of the activity based on the input provided by the user; and
a transmitter to provide the analysis information of the activity to a requester.

59. The system of claim 58, wherein the processing unit is further adapted to generate a transactional record of the activity based on the input provided by the user, and to analyze the transactional record of the activity to generate the analysis information of the activity.

60. The system of claim 58, wherein the activity is a sports activity.

61. The system of claim 58, further including an analysis information database to store the analysis information of the activity.

62. The system of claim 58, wherein the requester is the user.

63. The system of claim 58, wherein the analysis information is provided to the user via voice, graphics, animation, or textual form.

64. The system of claim 58, wherein the processing unit is further adapted to at least one of interpret voice input and interpret communication device input entries to process the input provided by the user.

65. The system of claim 64, wherein at least one of: a speaker-independent speech recognition engine, a speaker-dependent speech recognition engine, and a speaker pre-recorded custom utterances recognition engine is utilized by the processing unit to interpret voice input.

66. The system of claim 59, wherein the processing unit is further adapted to parse the input provided by the user and perform error correction on the input provided by the user based on at least one of a predefined vocabulary and grammar for user communication, and a free-form natural language interpretation grammar to generate the transactional record of the activity.

67. The system of claim 66, wherein the free-form natural language interpretation grammar is statistical language model (SLM) grammar.

68. The system of claim 58, wherein the processing unit is further adapted to at least one of: perform statistical analysis of the activity, perform pattern detection on a transactional record of the activity, create strategy recommendations for participants in the activity, create improvement recommendations for the participants in the activity, and provide comparisons of statistical analysis of the activity with a group of participants' averages or team averages for the activity.

69. The system of claim 59, wherein the processing unit to analyze the transactional record of the activity to generate the analysis information of the activity is further adapted to at least one of performing: scoring characterization, participant performance characterization, team performance characterization, temporal-based performance characterization, location-based performance characterization, and objects of the activity-based performance characterization.

70. The system of claim 68, wherein the processing unit is further adapted to:
describe a pattern by defining a triggering event in terms of at least one of activity transaction records and activity analysis records; and
define a statistical significance level for triggering the pattern.

71. The system of claim 58, wherein the processing unit is further adapted to at least one of: instantaneously deliver the analysis information at a time of request, deliver the analysis information at predetermined intervals of time from the time of request, deliver the analysis information at a predetermined point in an activity, deliver the analysis information when the activity pauses, deliver the analysis information at points of significant changes in statistics during an activity progression, and deliver the analysis information after the activity completion.

72. The system of claim 58, wherein the processing unit is further adapted to:
calculate temporal statistics of activity periods;
establish significance level thresholds for comparisons of activity statistics between the activity periods;
detect when the significance level thresholds are exceeded; and
log the exceeded significance level thresholds for delivery to the user.

73. The system of claim 58, wherein the analysis information of the activity is provided to a plurality of requesters.

74. The system of claim 58, wherein the processing unit is further adapted to provide an advertisement along with the analysis information of the activity.

75. The system of claim 58, wherein a plurality of communication devices of a plurality of users provide the input.

76. The system of claim 75, wherein the processing unit is further adapted to:
compare the inputs from the plurality of users; and
reward the users based on the inputs received.

77. The system of claim 75, wherein the processing unit is further adapted to:
time-stamp each of the inputs received from each of the plurality of communication devices; and
reconstruct an activity progression based on a conglomeration of the inputs from the plurality of communication devices.

78. A system for performing and delivering analysis of an activity, comprising:
means for receiving input from a communication device of a user;
means for processing the input provided by the user;
means for generating analysis information of the activity based on the input provided by the user; and
means for providing the analysis information of the activity to a requester.

79. The system of claim 78, further including:
means for generating a transactional record of the activity based on the input provided by the user; and
means for analyzing the transactional record of the activity to generate the analysis information of the activity.

80. The system of claim 78, wherein the activity is a sports activity.

81. The system of claim 78, further including means for storing the analysis information of the activity.

82. The system of claim 78, wherein the requester is the user.

83. The system of claim 78, wherein the analysis information is provided to the user via voice, graphics, animation, or textual form.

84. The system of claim 78, wherein the means for processing the input provided by the user includes at least one of means for interpreting voice input, and means for interpreting communication device input entries.

85. The system of claim 84, wherein the means for interpreting voice input utilizes at least one of: a speaker-independent speech recognition engine, a speaker-dependent speech recognition engine, and a speaker pre-recorded custom utterances recognition engine.

86. The system of claim 79, wherein the means for generating the transactional record of the activity includes means for parsing the input provided by the user and performing error correction on the input provided by the user based on at least one of a predefined vocabulary and grammar for user communication, and a free-form natural language interpretation grammar.

87. The system of claim 86, wherein the free-form natural language interpretation grammar is statistical language model (SLM) grammar.

88. The system of claim 78, further including at least one of: means for performing statistical analysis of the activity, means for performing pattern detection on a transactional record of the activity, means for creating strategy recommendations for participants in the activity, means for creating improvement recommendations for the participants in the activity, and means for providing comparisons of statistical analysis of the activity with a group of participants' averages or team averages for the activity.

89. The system of claim 79, wherein the means for analyzing the transactional record of the activity to generate the analysis information of the activity further includes at least one of: means for scoring characterizing, means for participant performance characterizing, means for team performance characterizing, means for temporal-based performance characterizing, means for location-based performance characterizing, and means for objects of the activity-based performance characterizing.

90. The system of claim 88, wherein the means for performing pattern detection on the transactional record of the activity includes:
means for describing a pattern by defining a triggering event in terms of at least one of activity transaction records and activity analysis records; and
means for defining a statistical significance level for triggering the pattern.

91. The system of claim 78, wherein the means for providing the analysis information of the activity to the requester includes at least one of: means for instantaneously delivering the analysis information at a time of request, means for delivering the analysis information at predetermined intervals of time from the time of request, means for delivering the analysis information at a predetermined point in an activity, means for delivering the analysis information when the activity pauses, means for delivering the analysis information at points of significant changes in statistics during an activity progression, and means for delivering the analysis information after the activity completion.

92. The system of claim 78, wherein the means for providing the analysis information of the activity to the requester includes:
means for calculating temporal statistics of activity periods;
means for establishing significance level thresholds for comparisons of activity statistics between the activity periods;
means for detecting when the significance level thresholds are exceeded; and
means for logging the exceeded significance level thresholds for delivery to the user.

93. The system of claim 78, wherein the analysis information of the activity is provided to a plurality of requesters.

94. The system of claim 78, wherein the means for providing the analysis information of the activity to the requester includes means for providing an advertisement along with the analysis information of the activity.

95. The system of claim 78, wherein a plurality of communication devices of a plurality of users provide the input.

96. The system of claim 95, further including:
means for comparing the inputs from the plurality of users; and
means for rewarding the users based on the inputs received.

97. The system of claim 95, further including:
means for time-stamping each of the inputs received from each of the plurality of communication devices; and
means for reconstructing an activity progression based on a conglomeration of the inputs from the plurality of communication devices.
